(19) United States
(12) Patent Application Publication
(10) Pub. No.: US 2012/0117019 A1
(43) Pub. Date: May 10, 2012

(54) RELATIONSHIP ANALYSIS ENGINE

(75) Inventors: Warren L. Wolf, Austin, TX (US); Manu Rehani, Portland, OR (US)

(73) Assignee: DW ASSOCIATES, LLC, Austin, TX (US)

(21) Appl. No.: 13/284,750

(22) Filed: Oct. 28, 2011

Related U.S. Application Data
(60) Provisional application No. 61/410,677, filed on Nov. 5, 2010.

(51) Int. Cl. G06N 5/04

(52) U.S. Cl. 706/52

(57) ABSTRACT

A relationship analysis engine includes a controller and a data miner to mine relationship information on a network. Sender nodes can be determined by the data miner or otherwise manually defined. Recipient nodes can be determined by the data miner or otherwise manually defined. An actionable analytics section analyzes messages that are transmitted between the sender nodes and the recipient nodes. The actionable analytics section produces historical analytics, real-time analytics, and predictive analytics associated with at least one relationship based on the analyzed transmitted messages and the mined relationship information. A relationship indicator is produced and displayed to represent the past, present, and predictive quality of relationship values associated with a relationship. The quality of relationship value can be determined, in part, by scores associated with waypoints in transitions between one quality of relationship value to another.

### CROSS REFERENCE TO RELATED APPLICATIONS

This application claims the benefit of U.S. Provisional Patent Application Ser. No. 61/410,677, filed Nov. 5, 2010, incorporated by reference herein.

### BACKGROUND

Business and personal relationships are rapidly moving from the “real world” person-to-person contacts to the “virtual world” of networks, computers, databases, and the like. In previous generations, business contacts were built and cultivated by physically meeting or spending time with a person over significant periods of time sometimes spanning months, years, or even a life time. Such relationships were difficult to quantify because so little information about the relationship was retained, other than perhaps in the memories of the persons, and in whatever papers associated with the relationship were left behind.

Today, relationships are increasingly built and cultivated using electronic means. Social networks connect people through time and space in ways never-before imagined. Business-to-business networks match willing buyers to willing sellers for the efficient transfer of goods and services. Online stores proliferate in the marketplace and facilitate the transfer of value for goods and services. People now communicate primarily through electronic means, including by email, text messages, blogs, tweets, social networks, and the like.

While abundant information about such relationships continues to be generated, such information is stored in disparate locations, with little to no coherency. It is difficult or impossible to quantify the quality of a relationship between different people or entities because the information is spread far and wide and little effort has been expended in making better sense of it. It would be desirable to understand the quality of relationships between oneself and others with whom one might interact. Such an understanding would lead to better and more productive business and personal relationships.

Accordingly, a need remains for a relationship analysis engine capable of analyzing and determining the quality of relationships among people and/or entities. Moreover, a need remains for efficiently communicating such information to others so that the quality of relationships can be recognized and improved upon. Embodiments of the invention address these and other limitations in the prior art.

### BRIEF DESCRIPTION OF THE DRAWINGS

FIG. 1 illustrates a block diagram of a relationship analysis engine according to an example embodiment of the present invention.

FIG. 2 illustrates a flow diagram of messages transmitted between sender and recipient nodes, in association with different contexts, according to an example embodiment of the present invention.

FIG. 3A illustrates selections of parameters for determining one or more relationships according to an example embodiment of the invention.

FIG. 3B illustrates an analysis and display of outcomes and observations associated with the selections of FIG. 3A.

FIG. 4A illustrates selections of parameters for determining one or more relationships according to another example embodiment of the invention.

FIG. 4B illustrates an analysis and display of one or more relationship associated with the selections of FIG. 4A.

FIG. 5 illustrates a diagram of waypoints between transitions from one quality of relationship value to another quality of relationship value according to some example embodiments.

FIG. 6 illustrates another diagram of waypoints between transitions from one quality of relationship value to another quality of relationship value according to some example embodiments.

FIG. 7 illustrates quality of relationship values and associated relationship indicator having icons that represent past, present, and predictive values according to some example embodiments.

FIG. 8 illustrates a customer relationship management (CRM) interface including the relationship indicator of FIG. 7.

FIG. 9 illustrates a contact list interface including the relationship indicator of FIG. 7.

The foregoing and other features of the invention will become more readily apparent from the following detailed description, which proceeds with reference to the accompanying drawings.

### DETAILED DESCRIPTION

Reference will now be made in detail to embodiments of the invention, examples of which are illustrated in the accompanying drawings. In the following detailed description, numerous specific details are set forth to enable a thorough understanding of the present invention. It should be understood, however, that persons having ordinary skill in the art may practice the present invention without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first component could be termed a second component, and, similarly, a second component could be termed a first component, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention include a relationship analysis engine and associated methods for analyzing and quantifying one or more relationships between sender and recipient nodes. The sender and recipient nodes are constructs that represent senders and receivers of messages on a network. Relationship information is mined on the network and based on such mined information, relationship indicators are generated, which serve multiple purposes including informing others about the quality of the relationships. Past, present, and predictive quality of relationship values can be produced and displayed.

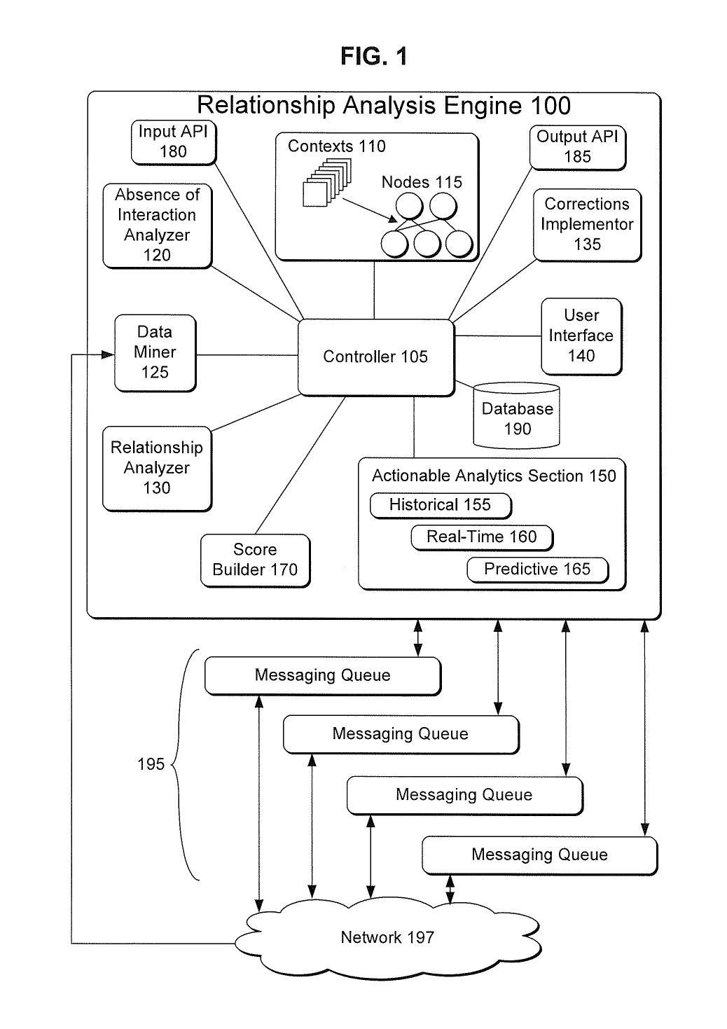

FIG. 1 illustrates a block diagram of a relationship analysis engine 100 according to an example embodiment of the present invention. The relationship analysis engine 100 can include a controller 105. The controller 105 is coupled to or otherwise associated with several different components, which can contribute to determining and quantifying the quality of one or more relationship between different persons or entities. The controller 105 can include a processor, circuit, software, firmware, and/or any combination thereof. Indeed, any of the components of the relationship analysis engine 100 can include a processor, circuit, software, firmware, and/or any combination thereof. It will be understood that one or more of the components of the relationship analysis engine 100 can be part of or otherwise implemented by the controller 105.

A data miner 125 is coupled to or otherwise associated with the controller 105 and can mine relationship information on a network (e.g., 197), such as the Internet, a local area network, or the like. The data miner 125 can determine or otherwise define a plurality of sender nodes, such as nodes 115. Each sender node represents a sender of a message, as further described in detail below. In addition, the data minder 125 can determine or otherwise define a plurality of recipient nodes, such as nodes 115. Each recipient node represents a receiver of a message, as further described in detail below.

The data miner 125 can automatically determine one or more contexts 110 in which each message is transmitted between a sender node and a recipient node. A context can include, for example, a work-related context, a personal friendship context, an acquaintance context, a business transaction context, or the like. The data miner 125 can also automatically determine a timing sequence for when each message is transmitted between the sender node and the recipient node.

An actionable analytics section 150 is coupled to or otherwise associated with the controller 105 and can analyze messages that are transmitted between the sender nodes and the recipient nodes. The messages can be received directly from one or more message queues such as message queues 195, analyzed, and returned to the message queues. Alternatively, the messages can be received over the network 197 by the data miner 125. The actionable analytics section 150 can produce historical analytics 155, real-time analytics 160, and predictive analytics 165 associated with at least one relationship based on the analyzed transmitted messages, the mined relationship information, the one or more contexts 110, and/or the timing sequence. The actionable analytics section 150 can also generate a relationship indicator for the relationship, which can include different icons, patterns, and/or colors representing past, present, and predictive quality of relationship values, as further described in detail below.

A relationship analyzer 130 can determine one or more waypoints between transitions from one quality of relationship value to another. Such waypoints can be scored using a score builder 170. In addition, the quality of relationship values themselves can be assigned a score using the score builder 170. The scores can be used in determining the past, present, and predictive quality of relationship values, as further described in detail below. The relationship analyzer 130 can be coupled to or otherwise associated with the controller 105, and can determine whether the relationship is productive or non-productive. The determination of whether the relationship is productive or non-productive can be made based on the context in which the message is sent or received. The relationship analyzer 130 can also determine the weak points and/or the strong points of a relationship.

The analysis engine 100 can include a user interface 140. The user interface 140 can receive input from a user to manually define the sender nodes and the recipient nodes (e.g., 115). In other words, constructs of sender nodes and recipient nodes can be built, which represent the persons or entities that actually send and receive messages. Moreover, the user interface 140 can receive input from a user to manually define one or more contexts 110 in which each message is transmitted between a sender node and a recipient node.

The analysis engine 100 can further include a corrections implementor 135, which can be coupled to or otherwise associated with the controller 105. The corrections implementor 135 can detect one or more inaccuracies in the mined relationship information and automatically correct such inaccuracies. For instance, if weak points of a relationship should have been assessed as strong points, or vice versa, then the corrections implementor 135 can correct such inaccuracies and thereby improve the understanding of the relationship.

In some cases, an absence of interaction can be used to draw certain conclusions. An absence of interaction analyzer 120 can be coupled to or otherwise associated with the controller 105, and can detect such absences of interaction. For instance, if a sender node sends a message to a recipient node, and the recipient node fails to reply to the message, then a conclusion can be drawn by the absence of interaction analyzer 120. The conclusion can be that the recipient is simply unavailable to respond. Alternatively, the conclusion can be that there is a flaw in the relationship between the sender node and the recipient node.

The actionable analytics section 150 can produce the historical analytics 155, the real-time analytics 160, and the predictive analytics 165 using the corrected inaccuracies of the corrections implementor 135, the absence of interaction detection of the absence of interaction analyzer 120, and the determination of the relationship analyzer 130.

An input application programming interface (API) 180 provides an input interface to the relationship analysis engine 100 from one or more third party applications or software. For example, the input API 180 can allow an interface to multiple modes of data feed including video, voice, and/or text information. In addition, an output API 185 provides an output interface from the relationship analysis engine 100 to one or more third party applications or software. For example, the output API 185 can allow third party applications or software to utilize the analysis engine 100 and display information received from the analysis engine 100 in their own user interface. The analysis engine 100 can provide real-time feedback on the quality of relationships between and among the nodes through the user interface 140, the input API 180, and/or the output API 185.

The relationship analysis engine 100 can also include a database 190, which can be coupled to or otherwise associated with the controller 105. The database 190 can store any information related to any of the components of the relationship analysis engine 100, including, for example, relationship information mined by the data miner 125, historical analytics 155, real-time analytics 160, predictive analytics 165, scores generated by the score builder 170, suggestions and tracers to display specific exhibits for the scores, and the like.

The relationship analysis engine 100 can be embodied in various forms. For example, the relationship analysis engine 100 can be operated using a dedicated rack-mount hardware system associated with a datacenter. In some embodiments, the relationship analysis engine 100 operates in association with a computing device or computer. In some embodiments, the relationship analysis engine 100 is a widget that can be installed or otherwise associated with a web page. In some embodiments, the relationship analysis engine 100 is embodied as a smart-phone application. In some embodiments, the relationship analysis engine 100 is an application associated with a social network. In some embodiments, the relationship analysis engine 100 is an add-on for relationship management software such as customer relationship management (CRM) software, vendor resource management (VRM) software, and/or environmental resource management (ERM) software, or the like.

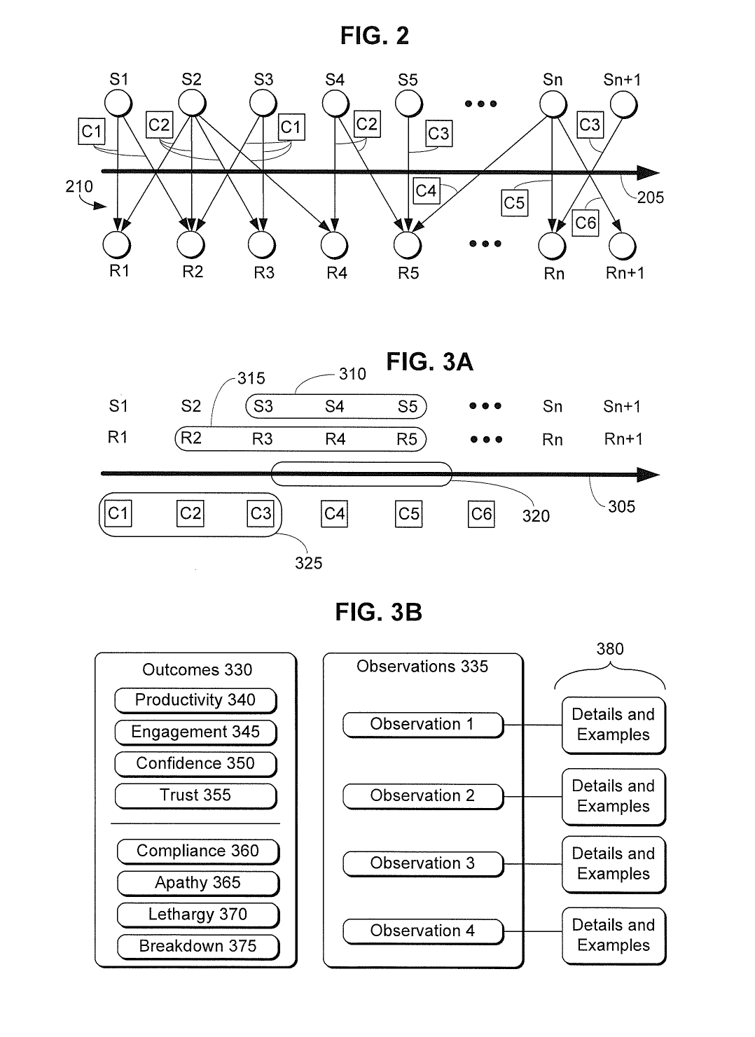

FIG. 2 illustrates a flow diagram of messages 210 transmitted between sender nodes (e.g., S1, S2, S3, S4, S5, . . . , Sn, Sn+1) and recipient nodes (e.g., R1, R2, R3, R4, R5, . . . , Rn, Rn+1), in association with different contexts (e.g., C1, C2, C3, C4, C5, and C6), according to an example embodiment of the present invention.

The messages 210 are transmitted between the sender nodes and the recipient nodes in accordance with a timing sequence 205. Each of the messages 210 can have associated therewith a context, which can be different from one message to the next. For example, as shown in FIG. 2, the messages sent between S1 and received by R1 and R2 can have a context C1 associated therewith. By way of another example, the messages sent between Sn and recipients R5, Rn, and Rn+1 can have associated therewith contexts C4, C5, and C6, respectively. It will be understood that messages sent from a given sender node can have the same or different contexts.

The sender nodes are representative of senders of messages, which can be persons, entities, computers, or the like. The recipient nodes are representative of receivers of messages, which can be persons, entities, computers, or the like. Each node can represent a single person or entity, or alternatively, a group of people or entities. For instance, a node can represent a subscriber list to a world wide audience. The messages 210 can include e-mails, blogs, short message service (SMS) text messages, posts, or the like, and can be organized as threads.

The actionable analytics section 150 (of FIG. 1) can produce the historical analytics 155, the real-time analytics 160, and the predictive analytics 165 pertaining to one or more relationships based on one or more contexts and the timing sequence.

FIG. 3A illustrates selections of parameters for determining one or more relationships according to an example embodiment of the invention. One or more sender nodes can be selected, such as sender nodes 310. One or more receiver nodes can be selected, such as receiver nodes 315. A time interval of interest 320 can be selected on the time sequence 305. One or more contexts can be selected, such as contexts 325. It will be understood that these are exemplary selections, and any combination of parameters can be selected. The selection can be made, for example, through the user interface 140, the input API 180, and/or the output API 185. In some embodiments, the selection is made algorithmically and/or automatically.

FIG. 3B illustrates an analysis and display of outcomes and observations associated with the selections of FIG. 3A. After the selection of parameters, outcomes 330 and/or observations 335 can be generated and/or displayed. The outcomes 330 and/or observations 335 are based on the selection of parameters, the mined relationship information, and other determinations as set forth in detail above with reference to FIGS. 1, 2, and 3A. It will be understood that the relationship analysis engine 100, or components thereof, can produce the outcomes 330 and/or the observations 335.

The outcomes can include one or more quality of relationship values, such as productivity 340, engagement 345, confidence 350, trust 355, compliance 360, apathy 365, lethargy 370, and/or breakdown 375. The observations 335 can include one or more observations. For example, observation 1 can be “Lack of communication of outcome.” Observation 2 can be “Emphasis on action items.” Observation 3 can be “Partial acknowledgement of purpose.” Observation 4 can be “Disconnected action items.” It will be understood that these are exemplary observations, and other similar or different kinds of observations can be made.

In addition, details and examples (e.g., 380) can provide further detail and/or examples of the observations 335. The details and examples can include buttons 380, which can be selected so that the further detail and/or examples of the observations 335 and/or outcomes 330 can be displayed.

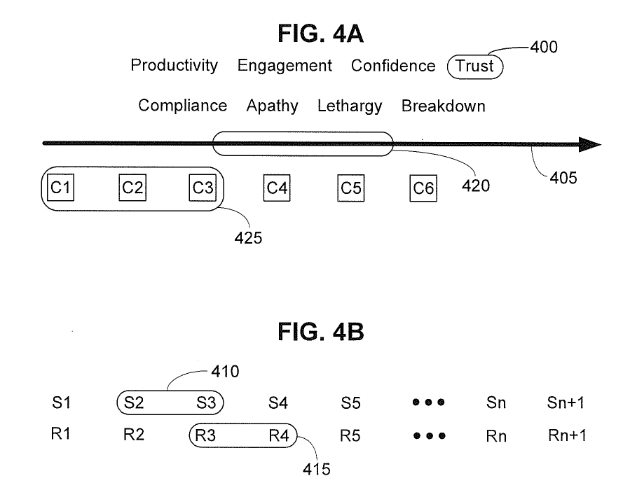

FIG. 4A illustrates selections of parameters for determining one or more relationships according to another example embodiment of the invention. One or more quality of relationship values, such as trust 400, can be selected. A time interval of interest 420 can be selected on the time sequence 405. One or more contexts can be selected, such as contexts 425. It will be understood that these are exemplary selections, and any combination of parameters can be selected. The selection can be made, for example, through the user interface 140, the input API 180, and/or the output API 185. In some embodiments, the selection is made algorithmically and/or automatically.

FIG. 4B illustrates an analysis and display of one or more relationship associated with the selections of FIG. 4A. After the selection of parameters, one or more sender nodes, such as sender nodes 410, can be highlighted or otherwise displayed, which correspond to the prior selections. Moreover, one or more recipient nodes, such as recipient nodes 415, can be highlighted or otherwise displayed, which correspond to the prior selections. It will be understood that the highlighted sender nodes 410 and the highlighted recipient nodes 415 are exemplary, and other similar or different kinds of selections and highlights can be made.

The determination for which of the sender nodes and recipient nodes are to be highlighted or otherwise displayed is made based on the selection of parameters, the mined relationship information, and other determinations as set forth in detail above with reference to FIGS. 1, 2, and 4A. It will be understood that the relationship analysis engine 100, or components thereof, can produce the highlights or otherwise display the sender nodes 410 and/or the recipient nodes 415. Moreover, the sender nodes 410 and/or the recipient nodes 415 can be highlighted or otherwise displayed in accordance with the determinations of quality of relationships, which conform to the selections described above.

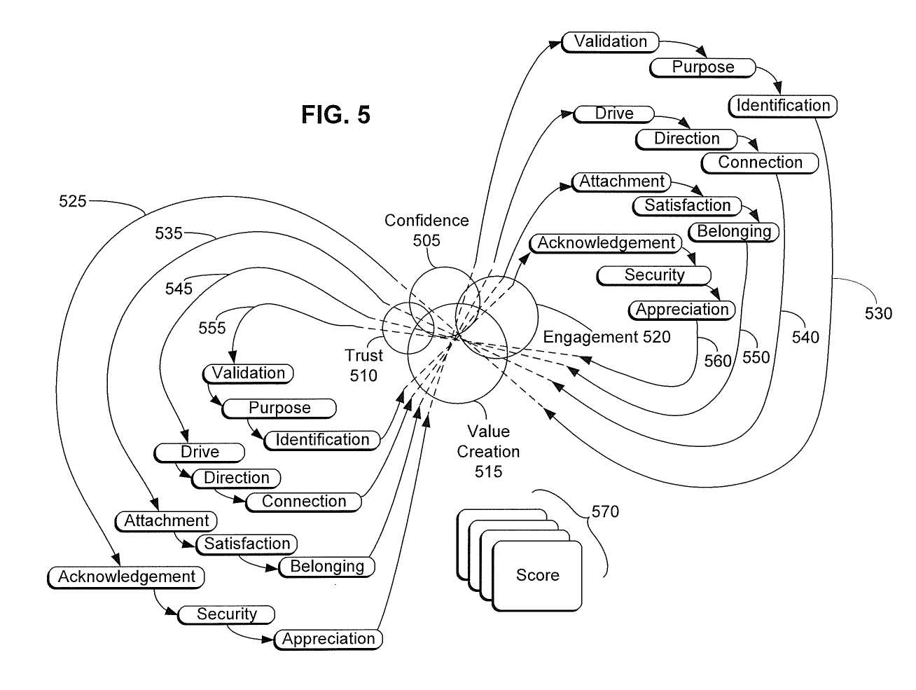

FIG. 5 illustrates a diagram of waypoints between transitions from one quality of relationship value to another quality of relationship value according to some example embodiments. The quality of relationship values can include, for example, trust 510, confidence 505, engagement 520, and/or value creation 515. These quality of relationship values represent values that are similar to or the same as the outcomes of trust 355, confidence 350, engagement 345, and productivity 340, respectively, discussed above with reference to FIG. 3B.

A relationship can transition from one quality value to any other quality value. For example, the relationship can transition from trust 510 to confidence 505, from confidence 505 to value creation 515, from engagement 520 to trust 510, from confidence 505 to engagement 520, and so forth. In the course of such transitions, the relationship can pass through various waypoints. In other words, the relationship analyzer 130 (of FIG. 1) can determine one or more waypoints between transitions from one quality of relationship value to another quality of relationship value.

The waypoints can be arranged along different paths. For instance, path 525 can be associated with value creation 515, and along path 525, the relationship can pass through waypoints of acknowledgement, security, and appreciation. The path 525 can continue to path 530, which can also be associated with value creation 515. Along path 530, the relationship can pass through waypoints of validation, purpose, and identification.

By way of another example, path 535 can be associated with engagement 520, and along path 535, the relationship can pass through waypoints of attachment, satisfaction, and belonging. The path 535 can continue to path 540, which can also be associated with engagement 520. Along path 540, the relationship can pass through waypoints of drive, direction, and connection.

By way of yet another example, path 545 can be associated with confidence 505, and along path 545, the relationship can pass through waypoints of drive, direction, and connection. The path 545 can continue to path 550, which can also be associated with confidence 505. Along path 550, the relationship can pass through waypoints of attachment, satisfaction, and belonging.

By way of still another example, path 555 can be associated with trust 510, and along path 555, the relationship can pass through waypoints of validation, purpose, and identification. The path 555 can continue to path 560, which can also be associated with trust 510. Along path 560, the relationship can pass through waypoints of acknowledgement, security, and appreciation.

It will be understood that the paths and waypoints disclosed herein are exemplary, and other similar paths and waypoints can be associated with the quality of relationship values of trust 510, confidence 505, engagement 520, and/or value creation 515.

The score builder 170 (of FIG. 1) can assign a score (e.g., 570) to one or more of the waypoints. The scores among the waypoints can be different in comparison one with another. For example, the score for the waypoint of appreciation along path 525 can be higher than the score for the waypoint of attachment along path 550. When a relationship passes through one of the waypoints, the score builder 170 can assign or otherwise add to the relationship the score associated with the given waypoint. The overall score assigned by the score builder 170 to a given relationship can be used in the determinations made by the relationship analyzer (130 of FIG. 1) and/or other components of the relationship analysis engine 100.

Furthermore, the score builder 170 can assign or otherwise add to the relationship a score (e.g., 570) for each quality of relationship value attained by the relationship. For example, a different score can be associated with each of the quality of relationship values of trust 510, confidence 505, engagement 520, and value creation 515, and the associated score can be assigned to the relationship having the particular quality of relationship value. The overall score assigned by the score builder 170 to a given relationship can include this aspect and be used in the determinations made by the relationship analyzer (130 of FIG. 1) and/or other components of the relationship analysis engine 100.

For example, the actionable analytics section 150 (of FIG. 1) can produce the historical analytics 155, the real-time analytics 160, and the predictive analytics 165 pertaining to one or more relationships based on the score of the one or more waypoints, the score for the quality of relationship, and/or the overall score assigned to the relationship. The messages from which relationship information is extracted can be used to determine the different paths and/or waypoints. The messages can be analyzed, categorized, sorted, grouped, and/or tagged in terms of nodes (e.g., sender or receiver), contexts, and/or waypoints.

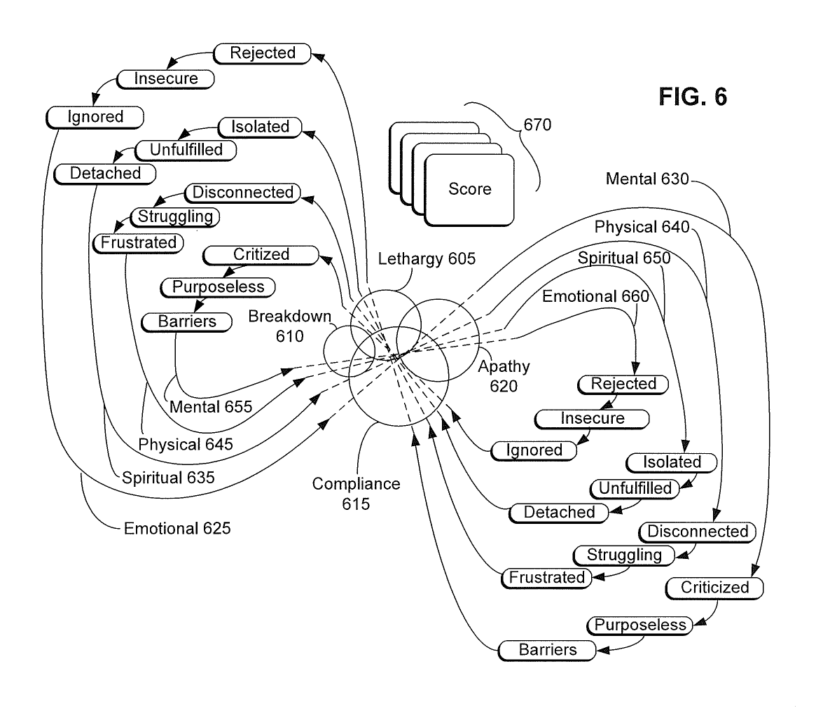

FIG. 6 illustrates another diagram of waypoints between transitions from one quality of relationship value to another quality of relationship value according to some example embodiments. The quality of relationship values can include, for example, breakdown 610, lethargy 605, apathy 620, and/or compliance 615. These quality of relationship values represent values that are similar to or the same as the outcomes of breakdown 375, lethargy 370, apathy 365, and compliance 360, respectively, discussed above with reference to FIG. 3B.

A relationship can transition from one quality value to any other quality value. For example, the relationship can transition from breakdown 610 to lethargy 605, from lethargy 605 to compliance 615, from apathy 620 to breakdown 610, from lethargy 605 to apathy 620, and so forth. It will also be understood that the relationship can transition from one quality of relationship value illustrated in FIG. 6 to another quality of relationship value illustrated in FIG. 5. It will also be understood that the relationship can transition from one quality of relationship value illustrated in FIG. 5 to another quality of relationship value illustrated in FIG. 6.

In the course of such transitions, the relationship can pass through various waypoints. In other words, the relationship analyzer 130 (of FIG. 1) can determine one or more waypoints between transitions from one quality of relationship value to another quality of relationship value.

The waypoints can be arranged along different paths. For instance, emotional path 625 can be associated with breakdown 610, and along path 625, the relationship can pass through waypoints of rejected, insecure, and ignored. The path 625 can continue to mental path 630, which can also be associated with breakdown 610. Along path 630, the relationship can pass through waypoints of criticized, purposeless, and barriers.

By way of another example, spiritual path 635 can be associated with lethargy 605, and along path 635, the relationship can pass through waypoints of isolated, unfulfilled, and detached. The path 635 can continue to physical path 640, which can also be associated with lethargy 605. Along path 640, the relationship can pass through waypoints of disconnected, struggling, and frustrated.

By way of yet another example, physical path 645 can be associated with apathy 620, and along path 645, the relationship can pass through waypoints of disconnected, struggling, and frustrated. The path 645 can continue to spiritual path 650, which can also be associated with apathy 620. Along path 650, the relationship can pass through waypoints of isolated, unfulfilled, and detached.

By way of still another example, mental path 655 can be associated with compliance 615, and along path 655, the relationship can pass through waypoints of criticized, purposeless, and barriers. The path 655 can continue to emotional path 660, which can also be associated with compliance 615. Along path 660, the relationship can pass through waypoints of rejected, insecure, and ignored.

It will be understood that the paths and waypoints disclosed herein are exemplary, and other similar paths and waypoints can be associated with the quality of relationship values of breakdown 610, lethargy 605, apathy 620, and compliance 615.

The score builder 170 (of FIG. 1) can assign a score (e.g., 670) to one or more of the waypoints. The scores among the waypoints can be different in comparison one with another. For example, the score for the waypoint of ignored along path 625 can be higher than the score for the waypoint of rejected along path 660. When a relationship passes through one of the waypoints, the score builder 170 can assign or otherwise add to the relationship the score associated with the given waypoint. The overall score assigned by the score builder 170 to a given relationship can be used in the determinations made by the relationship analyzer (130 of FIG. 1) and/or other components of the relationship analysis engine 100.

Furthermore, the score builder 170 can assign or otherwise add to the relationship a score for each quality of relationship value attained by the relationship. For example, a different score can be associated with each of the quality of relationship values of breakdown 610, lethargy 605, apathy 620, and/or compliance 615, and the associated score can be assigned to the relationship having the particular quality of relationship value. The overall score assigned by the score builder 170 to a given relationship can include this aspect and be used in the determinations made by the relationship analyzer (130 of FIG. 1) and/or other components of the relationship analysis engine 100. It will be understood that the score that is added can be a negative score, thereby negatively affecting the overall score assigned to the relationship.

The actionable analytics section 150 (of FIG. 1) can produce the historical analytics 155, the real-time analytics 160, and the predictive analytics 165 pertaining to one or more relationships based on the score of the one or more waypoints, the score for the quality of relationship, and/or the overall score assigned to the relationship. The messages from which relationship information is extracted can be used to determine the different paths and/or waypoints. The messages can be analyzed, categorized, sorted, grouped, and/or tagged in terms of nodes (e.g., sender or receiver), contexts, and/or waypoints.

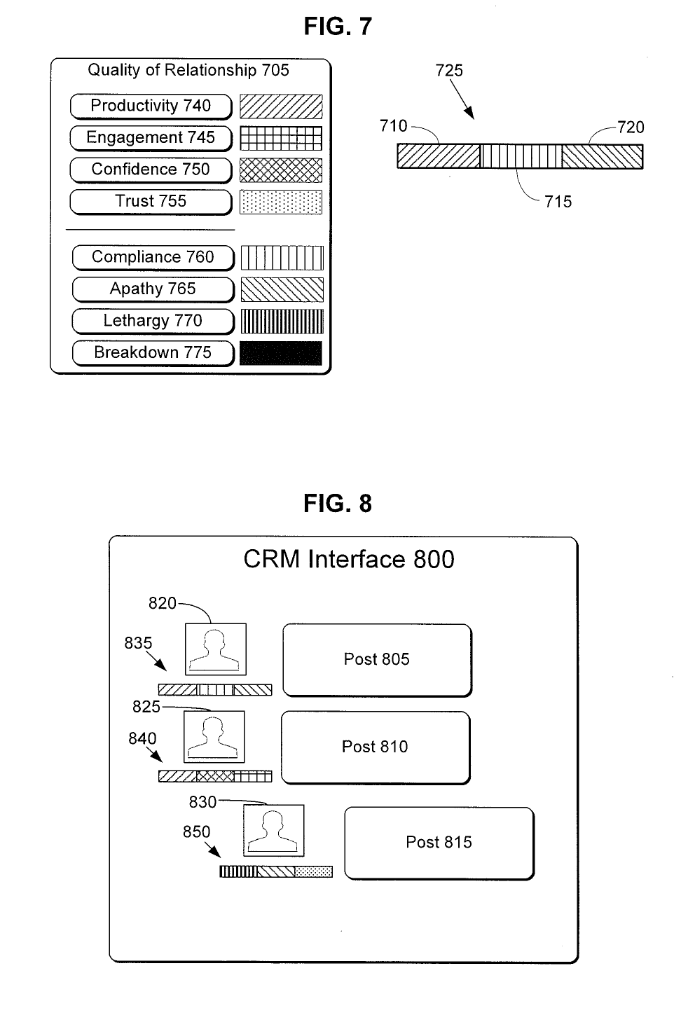

FIG. 7 illustrates quality of relationship values 705 and an associated relationship indicator 725 having icons (e.g., 710, 715, and 720) that represent past, present, and predictive values, respectively, according to some example embodiments.

The actionable analytics section 150 can generate the relationship indicator (e.g., 725) for one or more relationships. The relationship indicator 725 includes an indicator for a past quality of relationship value 710 associated with the historical analytics 155, a present quality of relationship value 715 associated with the real-time analytics 160, and a predictive quality of relationship value 720 associated with the predictive analytics 165.

The relationship indicator can include three adjacent or proximately located icons. For example, a first icon 710 can indicate the past quality of relationship value, a second icon 715 can indicate the present or real-time quality of relationship value, and a third icon 720 can indicate the predictive quality of relationship value. It will be understood that while the icons show a different pattern for each quality of relationship value, alternatively, each icon can show a different color or shape to distinguish one quality of relationship value from another. In some embodiments, a gradient of colors is used such that an individual color within the gradient of colors represents an individual quality of relationship value. Indeed, any differentiating aspect of the icons can be used to allow an observer to quickly distinguish and identify the quality of relationship value associated with the past, present, and predicted future quality of relationship.

More specifically, the past quality of relationship value indicated by the first icon 710 includes a representation for productivity 740, engagement 745, confidence 750, trust 755, compliance 760, apathy 765, lethargy 770, and/or breakdown 775. Similarly, the present quality of relationship value indicated by the second icon 715 includes a representation for productivity 740, engagement 745, confidence 750, trust 755, compliance 760, apathy 765, lethargy 770, and/or breakdown 775. The predictive quality of relationship value indicated by the third icon 720 includes a representation for productivity 740, engagement 745, confidence 750, trust 755, compliance 760, apathy 765, lethargy 770, and/or breakdown 775.

FIG. 8 illustrates a customer relationship management (CRM) interface 800 including relationship indicators such as those described with reference to FIG. 7. Relationship indicators, such as 835, 840, and 850 are configured to indicate the past, present, and predictive quality of relationship values for users, such as 820, 825, and 830, respectively, of a customer relationship management (CRM) system 800. The quality of relationship indicators can represent a quality of relationship between the users and the owner of the CRM system 800. Alternatively, the quality of relationship indicators can represent a quality of relationship between a user and another user or group of users of the CRM system 800. In this manner, the users can quickly assess the quality of relationship for themselves and others. This leads to better and more productive business and personal relationships. It also allows for the relationships to be recognized and improved upon.

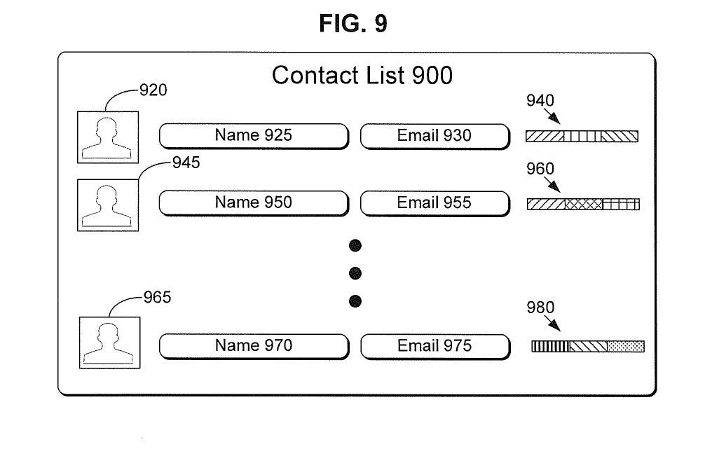

FIG. 9 illustrates a contact list interface 900 including relationship indicators such as those described with reference to FIG. 7. Relationship indicators, such as 940, 960, and 980 are configured to indicate the past, present, and predictive quality of relationship values for contacts, such as contacts 920, 945, and 965, respectively, of the contact list interface 900. The quality of relationship indicators can represent a quality of relationship between the contacts and the owner of the contact list or interface 900. Alternatively, the quality of relationship indicators can represent a quality of relationship between an owner of the list and another contact or group of contacts associated with the contact list or interface 900. In this manner, the owner of the contact list can quickly assess the quality of relationship for themselves and others. As mentioned above, this leads to better and more productive business and personal relationships. It also allows for the relationships to be recognized and improved upon.

As shown in FIG. 9, each contact (e.g., 920, 945, and 965) can have associated therewith a name (e.g., 925, 950, and 970, respectively), an email address (e.g., 930, 955, and 975, respectively), and/or any other suitable identifying information.

The relationship analysis engine 100 can cause the relationship indicators to be embedded in various forms and applications. For example, the relationship analysis engine 100 can embed or otherwise associate the relationship indicators with a widget that can be installed or otherwise associated with a web page. In some embodiments, the relationship analysis engine 100 can embed or otherwise associate the relationship indicators in a smart-phone application. In some embodiments, the relationship analysis engine 100 can embed or otherwise associate the relationship indicators in a social network. In some embodiments, the relationship analysis engine 100 can embed or otherwise associate the relationship indicators with an add-on feature for relationship management software such as customer relationship management (CRM) software, vendor resource management (VRM) software, and/or environmental resource management (ERM) software, or the like. The relationship indicators can be embedded or otherwise associated with any electronic device, application, and/or medium of communication, which can convey information to a person, machine, or entity.

Although the foregoing discussion has focused on particular embodiments, other configurations are contemplated. For example, methods for analyzing relationships as set forth herein are also disclosed. A method for analyzing relationship can include mining relationship information on a network, defining a plurality of sender nodes, each sender node representing a sender of a message, defining a plurality of recipient nodes, each sender node representing a receiver of a message, analyzing messages that are transmitted between the sender nodes and the recipient nodes, and producing historical analytics, real-time analytics, and predictive analytics associated with at least one relationship based on the analyzed transmitted messages and the mined relationship information.

The relationship can be between the sender of the message and the receiver of the message. The method can further include generating a relationship indicator for the at least one relationship. The generating can include generating a past quality of relationship value associated with the historical analytics, generating a present quality of relationship value associated with the real-time analytics, and generating a predictive quality of relationship value associated with the predictive analytics.

The method can further include displaying the relationship indicator. Displaying can include displaying a first icon indicating the past quality of relationship value, displaying a second icon indicating the present quality of relationship value, and displaying a third icon indicating the predictive quality of relationship value.

Even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Embodiments of the invention can include one or more tangible computer-readable media storing non-transitory computer-executable instructions that, when executed by a processor, operate to perform steps of the techniques described herein.

The following discussion is intended to provide a brief, general description of a suitable machine or machines in which certain aspects of the invention can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciated that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Other similar or non-similar modifications can be made without deviating from the intended scope of the invention. Accordingly, the invention is not limited except as by the appended claims.

What is claimed is:

1. A relationship analysis engine, comprising:
a controller;
a data miner coupled to the controller and configured to mine relationship information on a network;
a plurality of sender nodes determined by the data miner, each sender node representing a sender of a message;
a plurality of recipient nodes determined by the data miner, each recipient node representing a receiver of a message; and
an actionable analytics section coupled to the controller and configured to analyze messages that are transmitted between the sender nodes and the recipient nodes,
wherein the actionable analytics section is configured to produce historical analytics, real-time analytics, and predictive analytics associated with at least one relationship based on the analyzed transmitted messages and the mined relationship information.

2. The relationship analysis engine of claim 1, wherein the actionable analytics section is configured to generate a relationship indicator for the at least one relationship, and the relationship indicator includes an indicator for (a) a past quality of relationship value associated with the historical analytics, (b) a present quality of relationship value associated with the real-time analytics, and (c) a predictive quality of relationship value associated with the predictive analytics.

3. The relationship analysis engine of claim 2, wherein the relationship indicator includes three adjacent icons, including:
a first icon indicating the past quality of relationship value;
a second icon indicating the present quality of relationship value; and
a third icon indicating the predictive quality of relationship value.

4. The relationship analysis engine of claim 3, wherein the relationship indicator is configured to indicate the past, present, and predictive quality of relationship values for users of a customer relationship management (CRM) system.

5. The relationship analysis engine of claim 3, wherein the relationship indicator is configured to indicate the past, present, and predictive quality of relationship values between an owner of a contact list and each of a plurality of contacts on the contact list.

6. The relationship analysis engine of claim 3, wherein the relationship indicator is configured to indicate the past, present, and predictive quality of relationship values between members of a social network.

7. The relationship analysis engine of claim 3, wherein:
the past quality of relationship value indicated by the first icon includes a representation for at least one of (a) productivity, (b) engagement, (c) confidence, (d) trust, (e) compliance, (f) apathy, (g) lethargy, and (g) breakdown;
the present quality of relationship value indicated by the second icon includes a representation for at least one of (a) productivity, (b) engagement, (c) confidence, (d) trust, (e) compliance, (f) apathy, (g) lethargy, and (g) breakdown; and
the predictive quality of relationship value indicated by the third icon includes a representation for at least one of (a) productivity, (b) engagement, (c) confidence, (d) trust, (e) compliance, (f) apathy, (g) lethargy, and (g) breakdown.

8. The relationship analysis engine of claim 7, further comprising a relationship analyzer to determine one or more waypoints between transitions from one quality of relationship value to another quality of relationship value.

9. The relationship analysis engine of claim 8, further comprising a score builder configured to assign a score to the one or more waypoints.

10. The relationship analysis engine of claim 9, wherein the score builder is configured to assign a score for each quality of relationship value including (a) productivity, (b) engagement, (c) confidence, (d) trust, (e) compliance, (f) apathy, (g) lethargy, and (g) breakdown.

11. The relationship analysis engine of claim 10, wherein the actionable analytics section is configured to produce the historical analytics, the real-time analytics, and the predictive analytics pertaining to the at least one relationship based on the score of the one or more waypoints and the score for the quality of relationship value.

12. The relationship analysis engine of claim 1, wherein the data miner is configured to automatically determine one or more contexts in which each message is transmitted between a sender node of the plurality of sender nodes and a recipient node of the plurality of receiver nodes.

13. The relationship analysis engine of claim 12, wherein the data miner is configured to automatically determine a timing sequence for when each message is transmitted between a sender node of the plurality of sender nodes and a recipient node of the plurality of recipient nodes.

14. The relationship analysis engine of claim 13, wherein the actionable analytics section is configured to produce the historical analytics, the real-time analytics, and the predictive analytics pertaining to the at least one relationship based on the one or more contexts and the timing sequence.

15. The relationship analysis engine of claim 1, further comprising a user interface configured to receive input from a user to manually define the plurality of sender nodes and the plurality of recipient nodes.

16. The relationship analysis engine of claim 1, further comprising a user interface configured to receive input from a user to manually define one or more contexts in which each message is transmitted between a sender node of the plurality of sender nodes and a recipient node of the plurality of recipient nodes.

17. The relationship analysis engine of claim 1, further comprising:
a corrections implementor coupled to the controller and configured to detect one or more inaccuracies in the mined relationship information and to automatically correct such inaccuracies;
an absence of interaction analyzer coupled to the controller and configured to detect an absence of interaction between a sender node of the plurality of sender nodes and a recipient node of the plurality of recipient nodes; and
a relationship analyzer coupled to the controller and configured to determine whether the at least one relationship is productive or non-productive,
wherein the actionable analytics section is configured to produce the historical analytics, the real-time analytics, and the predictive analytics using the corrected inaccuracies of the corrections implementor, the absence of interaction detection of the absence of interaction analyzer, and the determination of the relationship analyzer.

18. A method for analyzing relationships, comprising:
mining relationship information on a network;
defining a plurality of sender nodes, each sender node representing a sender of a message;
defining a plurality of recipient nodes, each sender node representing a receiver of a message;
analyzing messages that are transmitted between the sender nodes and the recipient nodes; and
producing historical analytics, real-time analytics, and predictive analytics associated with at least one relationship based on the analyzed transmitted messages and the mined relationship information.

19. The method of claim 18, wherein the at least one relationship is between the sender of the message and the receiver of the message, the method further comprising:
generating a relationship indicator for the at least one relationship, wherein generating the relationship indicator includes:
generating a past quality of relationship value associated with the historical analytics;
generating a present quality of relationship value associated with the real-time analytics; and
generating a predictive quality of relationship value associated with the predictive analytics;
displaying the relationship indicator, wherein displaying includes:
displaying a first icon indicating the past quality of relationship value;
displaying a second icon indicating the present quality of relationship value; and
displaying a third icon indicating the predictive quality of relationship value.

20. One or more tangible computer-readable media storing non-transitory computer-executable instructions that, when executed by a processor, operate to perform the method according to claim 18.
